(19) United States
(12) Patent Application Publication
(10) Pub. No.: US 2019/0374306 A1
(43) Pub. Date: Dec. 12, 2019

(54) DENTAL MILLING MACHINE

(71) Applicants: Martin HUBER, Pfarrwerfen (AT); Alfons WÖRMER, Bischofshofen (AT)

(72) Inventors: Martin HUBER, Pfarrwerfen (AT); Alfons WÖRMER, Bischofshofen (AT)

(21) Appl. No.: 16/479,007

(22) PCT Filed: Jan. 24, 2018
(86) PCT No.: PCT/EP2018/051724

§ 371 Date: Jul. 18, 2019

(30) Foreign Application Priority Data
Jan. 24, 2017 (EP) 17152819.3

(51) Int. Cl. A61C 3/02; B23Q 3/155

(52) U.S. Cl. CPC A61C 3/02; A61C 13/0003; B23Q 3/15526

(57) ABSTRACT

A dental milling machine comprising a workpiece holder (2) and a changer arm (10) is characterized in that the changer arm (10) has a substantially U-shaped gripping attachment (12) and in that a tool (14) of the dental milling machine (1) has a tool fixation element (16). The tool fixation element has grooves (18) or holding projections at two mutually opposed positions which face away from each other, over which grooves or holding projections the U-shaped gripping attachment (12) of the changer arm (10) can engage, wherein parts of the U-shaped gripping attachment (12), more particularly the side flanks (12a, 12b) of the U-shaped gripping attachment (12), make contact with the grooves (18) or holding projections of the tool fixation element (16) under preload.

The invention concerns a dental milling machine according to the preamble of claim 1.

Such dental milling machines with tool changers have been known for a long time. An example for this is the solution which is known from DD 233 791 A1. This solution comprises a cassette for receiving a plurality of tools which may be transported via a gripping arm. A disadvantage herewith is the necessity of taking additional measures in order to be able to handle individual tools.

From DE 100 39 525 A1 a tool changer is known as well, with the help of which a two-piece gripper may remove tools from magazine positions and take them to the desired position.

This solution has not gained acceptance either. The gripper there requires precise control and means an additional and cost-intensive activating element within the machine tool.

Furthermore, it has already been suggested to use forks at a changer arm of a machine tool, and remove the tool from a magazine and take it to the desired position via said forks.

With this solution, a comparatively slow movement of the changer arm is necessary in order to take the tools to the desired location. Attempts have resulted in tools possibly being lost if the movement is too fast.

Therefore, the invention is based on the task of creating a dental milling machine according to the preamble of claim 1 which allows also a fast tool change, without any additional costs being necessary.

This task is solved, in accordance with the invention, by claim 1, advantageous further embodiments result from the subordinate Claims.

In accordance with the invention, it is particularly favourable that the changer arm carries one or a number of gripping attachments which are substantially U-shaped. The gripping attachments make it possible to purposefully grip the tools at their tool fixation elements. The gripping attachments make contact with the fixation element in such a fashion that said is fixedly held under a preload. As a result of the preload, surprisingly, even a very fast movement of the changer arm is possible without any tools being lost, which considerably increases the reliability of the dental milling machine.

The fixation may be carried out in any suitable fashion. What is essential is engagement. The gripping attachment engages over the tool at its fixation element preferably by slightly more than 180 degrees. Together with the preload, the desired fixation may be guaranteed.

In spite of this engagement, a liberal insertion of the tool fixation element into the gripping attachment is possible. For this purpose, the changer arm is driven towards the tool laterally—with relation to the axis of the tool—, which is done at one altitude, such that the gripping attachment extends next to the fixation element and approaches it from the side. When engagement is made over the fixation element, the side flanks of the gripping attachment are, if necessary, spread open slightly or at least make firm contact with the fixation element. The gripping attachment may also end inside detents or snap-in noses at the ends of the side flanks which then hold the fixation element in such a fashion that it is undetachable.

For this purpose, the fixation element has grooves or at least holding projections. The grooves or holding projections extend cross-axis to the tool and are adapted to the gripping attachment, in particular to its side flanks, in their shapes.

In case of a circularly symmetrical shape of the grooves or holding projections, a gripping of the tool at the fixation element is possible independently of its rotational position. This insofar represents an advantageous embodiment.

Preferably, the changer arm is a changer arm which is movable in five axes, which also clamps the workpiece and supplies it to the milling work. The tool spindle, in contrast, is preferably space-fixed, such that insofar a 5/0 dental milling machine is provided.

It is to be understood that here, a dental milling machine means any sort of dental processing machine tools, i.e., for instance also dental grinding machines, dental disc grinding machines, dental drilling machines and the like, wherein, for the sake of simplicity, reference is made to “milling” here.

It is particularly favorable if two U-shaped gripping attachments are attached to the changer arm, which is, preferably at the same side. Both gripping attachments may then each take up one tool at it s fixation element and safely mount it.

The use of two mutually adjacent gripping attachments makes it possible to reduce the necessary movements of the changer arm. For example, the changer arm may then remove a tool from a tool magazine for the tool change, with the gripping attachments first being unloaded. For this purpose, it is driven towards the tool from the side, with its U-shaped gripping attachment, which is done in such a fashion that the gripping attachment and the fixation element are at the same altitude.

After snapping in, the changer arm then moves the tool to the proximity of the tool spindle. If necessary, a rotation of the changer arm by 180 degrees may be required for this, depending on the arrangement of the tool spindle relative to the tool magazine.

In this position, the changer arm now has one equipped and one unequipped gripping attachment. In this state, a tool is clamped inside the milling spindle which should now be replaced. For this purpose, the tool arm is driven towards the milling spindle from the side, with the unequipped gripping attachment, which is again done in such a fashion that the fixation element and the gripping attachment extend at the same altitude.

The gripping attachment snaps onto the fixation element and removes the tool from the tool spindle, wherein it is to be understood that the clamping chuck of the milling spindle is loosened for this purpose.

In accordance with the invention, it is always essential that the changer arm is driven closer from the side in order to snap the fixation element into the gripping attachment, and after this has been completed, that it is moved away from the respective current position of the tool in a fashion axially parallel, in the direction of the front end of the tool. This holds true both for the removal of the tool from the tool magazine and for the removal from the tool spindle.

After the tool to be exchanged has been removed, the changer arm with the other gripping attachment, which is the one carrying the new tool, is brought in front of said with the clamping chuck opened, which is, in such a fashion that the shank of the tool extends in front of the clamping chuck of the milling spindle and is substantially coaxial in relation to said.

The tool is now moved into the clamping chuck with its shank. The clamping chuck is closed, and after the fixation of the tool, which has insofar been carried out, the changer arm moves laterally, which is against the opening direction of the U of the gripping attachment of the now clamped tool.

As a result, the tool is detached from the gripping attachment concerned. The changer arm now moves away from the tool spindle into the direction towards the tool magazine, wherein it is, if necessary, depending on the spatial arrangement of these two, rotated or moved in any desired axes.

The worn tool or tool to be exchanged is now taken in front of an empty magazine position.

In one embodiment, the tool has an annular groove and is designed for being inserted into the position of the tool magazine. In this embodiment, the changer arm is held in front of this empty plug position and the shank of the tool is inserted in this position and is clamped there, if necessary. For the release of the tool, the gripping attachment is in turn moved laterally against the opening direction of the U, in such a fashion that the tool is located at the respective plug position inside the magazine.

This embodiment is particularly suitable for an upright reception of the tools inside the tool magazine.

Another embodiment is particularly suitable for a hanging reception of the tools inside the tool magazine. In this embodiment, the tool fixation element has two annular grooves or in, any case, two annular holding projections, which are, viewed in the axial direction of the tool, spaced apart from each other.

In this embodiment, the tool magazine has one U-shaped receptacle slot in each reception position of the tool, which receptacle slot fits over an annular groove of the tool. For equipping the magazine, the changer arm is activated in such a fashion that the U-shaped gripping attachment at the changer arm guides the tool at one altitude, such that the free annular groove of the tool and the U-shaped receptacle slot of the tool magazine correspond to each other.

In addition, the two Us face towards each other at an angle, which is, not precisely in an extension of 180 degrees in relation to each other, but in an extensional direction of approximately 90 degrees in relation to each other.

For the transfer of the tool from the plug position at the changer arm towards the receptacle slot of the tool magazine, the changer arm is now moved in such a fashion that the tool is inserted into the receptacle slot with its free annular groove. In this position, both annular grooves are first in engagement with the respective receptacle slot or the gripping attachment, respectively. The changer arm is now activated in such a fashion that the movement is made opposite to the open side of the gripping attachment.

In this direction, a lateral movement of the tool inside the receptacle slot is not possible since the respective side flank of the receptacle slot is acting against it. The tool is therefore detached from the gripping attachment, such that now both U-shaped gripping attachments of the changer arm are free, and the tool remains inside the tool magazine. It is either removed as being worn or it is available for further machining work.

Preferably, the gripping attachments each have flexible tongues which hold the tool clamped at the respective annular groove by themselves. For this purpose, for instance, the inside diameter of the gripping attachment may be slightly, such as, for example, 0.3 mm, smaller than the outside diameter of the annular groove concerned, which is, in the unloaded state, such that the flexible tongues of the gripping attachment are then spread open by the respective amount by means of insertion of the fixation element and the tool is securely held.

Even if the realization of the receptacle of the gripping attachment at the fixation element via annular grooves is preferred, it is to be understood that instead of this, any other cavities, for example, annular cavities, may also be employed. It is merely of importance to have the possibility of laterally approaching the gripping attachment for the purpose of engaging over the fixation element and securing the fixation of the fixation element of the gripping attachment. The annular grooves which are spaced apart from each other axially do not have to exhibit a precisely identical shape. However, it is preferred that it is possible for them to be engaged over equally by the gripping attachments and for the tool to be fixedly attached inside the gripping attachment.

In accordance with a further preferred further embodiment, one milling spindle should be provided inside the milling chamber, which milling spindle is arranged to be space-fixed and carries a tool-clamping chuck which guides a milling tool clamped in a basically known fashion, which milling spindle is more particularly fixedly attached to the base of the milling chamber. Due to the fixation of the milling spindle at the base of the milling chamber, the milling tool may be precisely positioned relative to the milling spindle inside the milling chamber, in order to make possible a desired removal of material from the workpiece.

Further advantages, details and features may be taken from the subsequent description of a number of exemplary embodiments with the help of the attached drawings, which show:

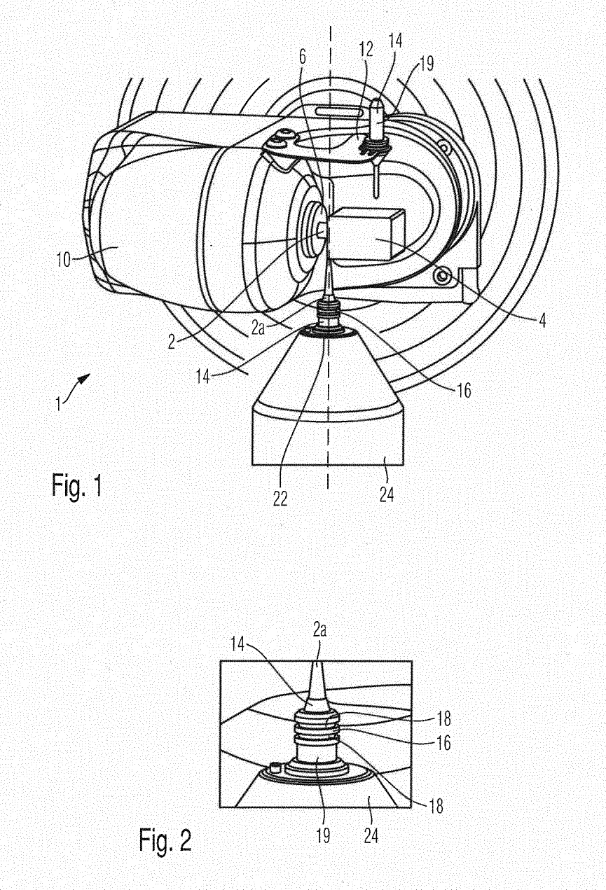

FIG. 1 a schematic depiction of a dental milling machine in one embodiment of the invention;

FIG. 2 an enlarged depiction of a detail from FIG. 1;

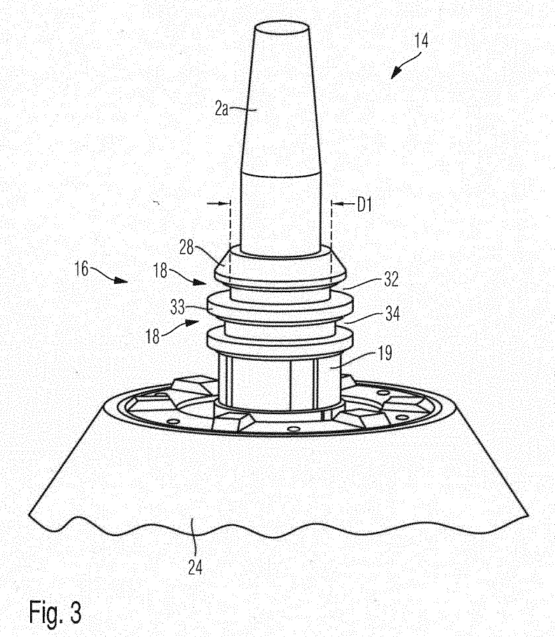

FIG. 3 another enlarged depiction corresponding to FIG. 2;

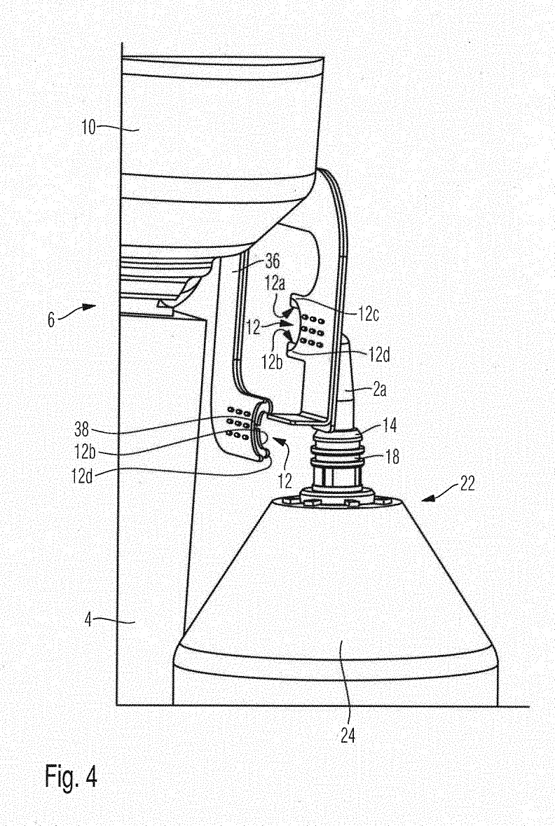

FIG. 4 a depiction of another embodiment of a dental milling machine in accordance with the invention;

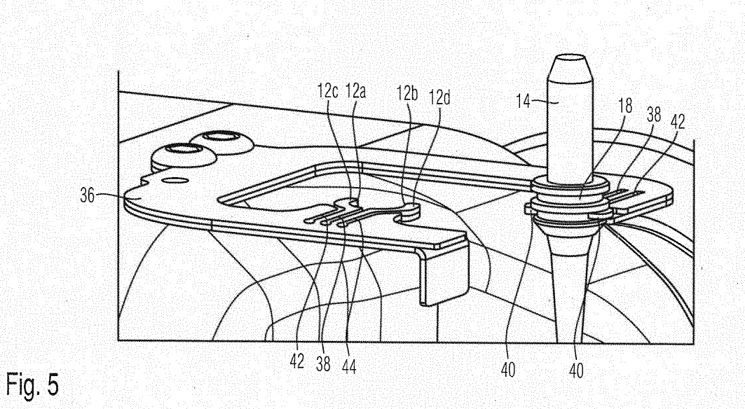

FIG. 5 a further depiction of a detail of the embodiment according to FIG. 4.

From the embodiment according to FIG. 1, a part of a dental milling machine 1 is visible. Dental milling machine 1 is designed for machining a workpiece 4.

For this purpose, workpiece 4 has a workpiece holder 2 which is held clamped inside a clamping chuck 6 of a changer arm 10 of dental milling machine 1. Changer arm 1 is movable in five spatial directions in the exemplary embodiments depicted, which is, in three translational and two rotary spatial directions.

Laterally, which is, outside the axis of clamping chuck 6 and workpiece 4, it carries a U-shaped gripping attachment 12.

U-shaped gripping attachment 12 is designed for receiving a tool 14 and to fixedly attach it. For this purpose, tool 14 has a workpiece fixation element 16 whose details are described further below.

Workpiece fixation element 16 has two adjacent annular grooves 18. These are shaped to be radially annular and are coaxial in relation to tool 14, and are in addition spaced apart from each other viewed in an axial direction.

Tool 14 additionally has a shank 19. This is designed for being held clamped inside a clamping chuck 22 of a spatially fixed tool spindle 24.

Tool fixation element 16 extends between an axial end portion 2a (cf. FIG. 2), which is designed for the machining executed by the tool, and shank 19 of tool 14.

From FIG. 1, a tool 14 is visible which is held clamped inside clamping chuck 22 of spindle 24, as well as a further tool which is attached to U-shaped gripping attachment 12. The orientation of these two tools 14 is opposite to each other.

When tool 14 is to be removed from spindle 24, tool 14 which is positioned inside gripping attachment 12 must first be taken to a tool magazine, such that gripping attachment 12 is free of the tool.

When this has been completed, changer arm 10 may then first be rotated by 180 degrees around what is referred to as the B-axis, i.e. the rotational axis of clamping chuck 6.

Gripping attachment 12 then extends laterally next to tool fixation element 16 of tool 14 which is clamped inside the spindle.

The orientation is performed in such a fashion that the U extends precisely at the altitude of upper ring 18 of the fixation element.

By means of a lateral motion, the gripping attachment is then pushed onto this annular groove 18. Clamping chuck 22 is loosened, and changer arm 10 is moved upwards, such that spindle 24 is without a tool.

Changer arm 10, in turn, is then rotated into the position according to FIG. 1, and the tool which is now positioned there is pushed from spindle 24 and into a free receptional position of the workpiece magazine, which is done with the help of the other annular groove 18 which has now turned out to be positioned on top after changer arm 10 has been rotated by 180 degrees.

From FIG. 2, the axial distance of both annular grooves 18 and the arrangement are visible in detail.

An enlarged depiction of tool 14 clamped inside spindle 24 is visible from FIG. 3. Fixation element 16 begins—viewed starting from axial end portion 2a—with a chamfer 28. Subsequent to this, there is the multiple arrangement of annular grooves 18. In the embodiment according to FIG. 3, an annular cavity 32 is provided. In the axial direction adjacent to this, there is an annular bridge 33, and then, as the second annular groove 18, a second annular cavity 34. Subsequent to this, shank 19 of the tool is provided.

A further embodiment of a dental milling machine in accordance with the invention is visible from FIG. 4.

In this embodiment, two gripping attachments 12 are provided, which is, at one mutual sheet 36 which is attached to changer arm 10. Each gripping attachment has flexible tongues 12c and 12d which form part of the U. Flexible tongue 12c has a side flank 12a, and flexible tongue 12d a side flank 12b. Side flanks 12a and 12b face towards each other.

As is visible from FIG. 4, the central leg of the U each has an internal radius, adapting it to the shape of annular grooves 18.

Additionally, one central slot 38 is provided for each, which improves the flexibility of flexible tongues 12c and 12d.

It is to be understood that the precise configuration may be adapted to the requirements in any fashion. What is essential, however, is the possibility of fixedly attaching annular grooves 18 of tool fixation element 16 inside gripping attachments 12. If necessary, small projections which face inwards and which, if applicable, further improve the clamping and make possible a snapping in as well, may also be provided at side flanks 12a and 12b which are arranged at the edges.

This is visible from FIG. 5, which Figure shows the projections 40 facing inwards.

Due to these projections, the wrap-around angle of gripping attachment 12 is slightly larger than 180 degrees each.

From FIG. 5, central slot 38 is visible too. For the improvement of the spring characteristics of flexible tongues 12c and 12d, moreover, additional slots 42 and 44 are provided at the sides of the central slot.

As is visible from FIG. 5, sheet 36 is sistered in part. This increases the stiffness in the direction of the axis of tool 14, but still allows the desired spring characteristics, wherein sistering is dispensed with in the area of flexible tongues 12c and 12d.

1. A dental milling machine comprising
a workpiece holder (2) and
a changer arm (10) carrying the workpiece holder (2),
wherein the changer arm (10) has a substantially U-shaped gripping attachment (12) and
wherein a tool (14) of the dental milling machine (1) has a tool fixation element (16) which has grooves (18) or holding projections at two positions which are spaced apart from each other, and over which grooves or holding projections the U-shaped gripping attachment (12) of the changer arm (10) is configured to engage,
wherein parts of the U-shaped gripping attachment (12) make contact with the grooves (18) or holding projections of the tool fixation element (16) under preload, or wherein the tool fixation element (16) is held clamped inside the U-shaped gripping attachment (12).

2. The dental milling machine according to claim 1,
wherein the changer arm (10) further has a clamping chuck (6) for receiving a workpiece holder (2) of a workpiece (4).

3. The dental milling machine according to claim 1,
wherein the changer arm (10) carries two mutually adjacent U-shaped gripping attachments (12) which are spaced apart from each other.

4. The dental milling machine according to claim 3,
wherein the U-shaped gripping attachments (12) have open sides which open sides are oriented opposite to each other,
wherein the U-shaped gripping attachments (12) are directed towards each other with their open sides, but are displaced in relation to each other.

5. The dental milling machine according to claim 1,
wherein the grooves (18) or holding projections are attached to a ring of the tool fixation element (16) which is fixed to the tool (14), and
wherein the grooves (18) are circular in shape.

6. The dental milling machine according to claim 4,
wherein the changer arm (10) has first flexible tongues (12c, 12d), and
wherein the first flexible tongues (12c, 12d) are flexible at one end and are mounted at another end, and
wherein when the changer arm (10) of the dental milling machine (1) approaches a tool which is clamped inside a clamping chuck (22) or a collet chuck of a tool spindle (24) of the dental milling machine, the first flexible tongues (12c, 12d) are configured to fixedly attach the tool (14) by pressure exerted onto the first flexible tongues (12c, 12d).

7. The dental milling machine according to claim 6,
wherein the collet chuck or the clamping chuck (22) of the tool spindle (24) grips and holds a shank (19) of the tool (14).

8. The dental milling machine according to claim 6,
wherein the tool fixation element (16) is shaped as a circular sleeve and the tool (14) is substantially pin-shaped,
wherein a maximum outside diameter (D1) of the groove (18) of the tool fixation element (16), which is substantially circular in a cross section, is maximally 0.5 mm larger than an inside diameter (D2) of the first flexible tongues (12c, 12d) in an unloaded state, and
wherein the groove (18) or a first annular cavity (32) on the tool fixation element (16) is designated for gripping the collet chuck or the clamping chuck of the changer arm (10).

9. The dental milling machine according to claim 8,
wherein the tool (14) has a second groove (18) or a second annular cavity (34) which is arranged to be spaced apart from an axial end section (2a) of the tool.

10. The dental milling machine according to claim 8,
wherein the ring of the tool fixation element (16), between the first groove (18) or the first annular cavity (32) and the second groove (18) or the second annular cavity (34), has an annular bridge (33) which is substantially circular in a cross section,
wherein a diameter of the substantially circular annular bridge (33) is larger than the diameter of at least one of the annular bridges which confine the first and second annular grooves (18) or annular cavities (32, 34), respectively, each at sides of the first and second annular grooves (18) or annular cavities (32, 34), respectively, which are positioned opposite of the substantially circular annular bridge (33).

11. The dental milling machine according to claim 17,
wherein the changer arm (10) carries a sheet (36) at the end of which the U-shaped gripping attachment (12) is provided,
wherein the side flanks (12a, 12b) of the U-shaped gripping attachment (12) have two flexible tongues (12c, 12d) which are spaced apart from each other.

12. The dental milling machine according to claim 11,
wherein the two flexible tongues fit into annular cavities (32, 34) and fill the annular cavities (32, 34) in a substantially U-shaped fashion.

13. The dental milling machine according to claim 12,
wherein the flexible tongues (12c, 12d) have a length which is larger than a radius of the annular cavities (32, 34) and which partly encompasses the annular cavities (32, 34).

14. The dental milling machine according to claim 11,
wherein the U-shaped gripping attachment (12) has flexible tongues (12c, 12d) with a width distinctly smaller and with an elasticity distinctly higher than a width and elasticity of the sheet (36), which sheet is flexible,
which flexible tongues (12c, 12d) are spaced apart from each other.

15. The dental milling machine according to claim 1,
wherein the changer arm (10) is movable in a direction of movement of substantially 90 degrees in relation to a longitudinal extension of the tool (14) and is configured to grip the tool in the grooves (18) via flexible tongues and remove the tool from the clamping chuck (22) and supply the tool to a tool magazine at which a further, correspondingly equipped tool may be taken up by the changer arm (10).

16. The dental milling machine according to claim 15,
wherein the changer arm (10) is movable such that a tool (14) accommodated inside the U-shaped gripping attachment (12) may be positioned in front of a receptacle slot of the tool magazine such that the tool (14) is configured for insertion into the receptacle slot of the tool magazine with the groove (18) or annular cavity (32, 34), and
wherein a side flank of the receptacle slot of the tool magazine is configured to act against a lateral movement of the tool (14) inside the receptacle slot in case of a lateral movement of the changer arm (10) at an angle of substantially 90 degrees in relation to a direction of movement of the changer arm (10) during the insertion of the tool (14) into the receptacle slot of the tool magazine.

17. The dental milling machine according to claim 1,
wherein parts of the U-shaped gripping attachment (12) that make contact with the grooves (18) or holding projections of the tool fixation element (16) comprise side flanks (12a, 12b).

18. The dental milling machine according to claim 3,
wherein the two mutually adjacent U-shaped gripping attachments (12) extend in a same plane.
